(19) United States
(12) Patent Application Publication
(10) Pub. No.: US 2015/0283934 A1
(43) Pub. Date: Oct. 8, 2015

(54) HEAVY-LOAD TRANSPORT VEHICLE FOR TRANSPORTING AN ELONGATED OBJECT

(71) Applicant: SCHEUERLE FAHRZEUGFABRIK GMBH, Pfedelbach (DE)

(72) Inventor: Florian Kern, Pfedelbach (DE)

(21) Appl. No.: 14/440,707

(22) PCT Filed: Nov. 6, 2013
(86) PCT No.: PCT/EP2013/003326

§ 371 Date: May 5, 2015

(30) Foreign Application Priority Data
Nov. 6, 2012 (DE) 10 2012 021 613.0
Nov. 6, 2012 (DE) 20 2012 010 545.0

(51) Int. Cl. B60P 3/40; B62D 53/06; B62D 13/02; F03D 1/00

(52) U.S. Cl. CPC B60P 3/40; F03D 1/005; B62D 53/067; B62D 53/061; B62D 13/02

(57) ABSTRACT

The invention relates to a heavy-load transport vehicle (10) for transporting an elongated object, having a tractor (14), a multi-axle trailer (16) and a carrier (18) for the elongated object supported on the trailer and on the tractor (14), wherein the trailer (16) and the carrier (18) are rotatable in relation to each other about a vertical axis (52) of the transport vehicle (10). According to the invention the carrier is supported on the tractor (14) via a goose-neck (22), the trailer (16) has at least one rigid axle (42, 44) and at least one steering axle (40), and in a steering operation mode during the journey, the steering axle (40) of the trailer (16) is steerable in relation to the trailer (16) about the vertical axis (52) as a function of the rotational movements of the carrier (18).

The invention relates to a heavy-load transport vehicle for transporting an elongated object, having a tractor, a multi-axle trailer and a carrier for the elongated object, the carrier being supported on the trailer and on the tractor, wherein the trailer and the carrier are rotatable in relation to each other about a vertical axis of the transport vehicle, the carrier is supported on the tractor via a goose-neck, the trailer has at least one rigid axle and at least one steering axle, and in a steering operation mode during the transport, the steering axle of the trailer is steerable in relation to the trailer about the vertical axis as a function of the rotational movements of the carrier.

Such a heavy-load transport vehicle is known from DE 10 2009 054 293 A1. In this document a transporter for long objects, in particular for long wood pieces, is described which has a tractor and a trailer. The long objects to be transported rest with their front end on a front bolster of a tractor and with their rear end on a bolster of the trailer, so that the goods to be transported provide a carrier between tractor and trailer. The first mentioned bolster is arranged on a transportation area of the tractor and is pivotable around a vertical central axis. In the same manner the bolster of the trailer is arranged on a chassis of the trailer and is rotable around a central vertical axis. The trailer has got at least one rigid axis and at least one steering axis, wherein in a first steering mode the steering axis of the trailer is steerable depending on the movement of the carrier around the vertical axis in relation to the trailer. For this purpose it is provided that for picking up a bolster angle between the rear bolster and the trailer slave cylinders and steering cylinders are provided, which engage on the axis distant from the turning point of the axis and the bolster respectively, in order to connect fluid dynamically one slave cylinder with one steering cylinder, so that the steering axis of the trailer steers in the direction of the elongated transport objects. By means of this fluid dynamic connection between slave cylinders and steering cylinders a pre-defined steering behavior of the trailer is given, which, for example, sets a certain curve radius of the trailer in relation to the curve radius of the tractor, which is generally a smaller curve radius, so that the part of the long goods protecting rewardly above the trailer do not have to run through a too big end radius.

As disclosed in the afore-mentioned document, a steering behavior of the trailer defined in such a way can be disadvantageous in some situations, since the danger is given that the trailer—for example when breaking strongly—is breaking out. In this situation the longitudinal axis of the trailer can still be aligned with the direction of the elongated goods to be transported or can be, for example, set off parallel to the longitudinal axis of the tractor, or can be in an intermediate position between the two afore-mentioned possibilities. Since, due to the fluid dynamic connection between slave cylinders and steering cylinders the steering angle of the steered axis of the trailer depends on the angle of the rear bolster, no defined steering behavior of the trailer is given in such a situation. In particular no steering behavior which counteracts a lateral breaking out of the trailer, or which prevents a further breaking out after a lateral breaking out has begun, is established.

For this purpose the afore-mentioned document provides that in the fluid dynamic connection a control unit is arranged, which is capable of breaking the fluid dynamic connection and to steer the steering cylinders as well as the slave cylinders directly in the desired sense, via the pressure of a hydraulic pump and generally with the help of a proportional valve and hydraulic lines so that a beginning breaking out is counteracted and/or a breaking out of the trailer which already has occurred is removed. Since this must be done automatically, namely without the operation of personnel, and in a very short time, namely within milliseconds after the breaking out has begun, it is necessary that the control unit firstly has got to detect the beginning of breaking out automatically.

For this purpose the position of rod in the slave cylinders or in the steering cylinders is detected and these are then used as angular sensors, the angle of the bolster of the trailer detected in this way is compared with the angle of the front bolster detected too. Based on these and other parameters the control unit then calculates counter measures and controls, starting from a hydraulic control device via hydraulic lines at least one steering cylinder and preferably a slave cylinder in such a way that a further breaking out of the trailer in the lateral direction is prevented. As a side effect of such a control further steering programs for the trailer can be implemented, which deviate from the standard-steering program, as it is given by the direct fluid dynamic connection between the slave cylinders and the steering cylinders.

The transport vehicle known from the afore-mentioned document has, due to the steering of the trailer, the advantage that in critical drive dynamic situations a breaking out of the trailer can be counteracted. This is done in that distributed automatically and without the help of the operating personal of the vehicle provides for a compensating steering movement. But the disadvantage is given that—in particular when transporting long objects—the maneuverability and the agility of the known transport vehicle is limited.

DE 25 54 047 A1 describes a multi axle trailer with a suspension allowing an axle adjustment, which has at least one steering axis and at least one rigid axis which are steerable via an all-wheel steering.

From EP 1 465 789 B1 a heavy-load transport vehicle for transporting a rotor blade of a wind turbine is known, having a multi-axle trailer connected to the tractor by the rotor blade itself. However, bending and torsion forces arising from driving dynamics act on the rotor blade, which might lead to invisible cracks or other damage of the rotor blade.

This risk can be avoided by using heavy-load transport vehicles for transporting a rotor blade of a wind turbine, by which the tractor is connected to the trailer via an elongated carrier for the rotor blade, wherein the elongated carrier is supported on the tractor and the trailer: the carrier absorbs possible bending and torsion forces arising from driving dynamics, so that these forces are not introduced into the rotor blade. For adapting rotor blades of various length as well as for improving maneuverability the carrier is commonly formed as a telescope carrier.

For heavy-load transport vehicles of this kind, the rotor blade can either be lashed or clamped either in its whole on the carrier or only in the region of its root above the tractor. In the first mentioned case, the length of the vehicle cannot be changed during transport, so that the vehicle, due to the large distance between tractor and trailer, has only minor agility and maneuverability, particularly when driving through curves. On the other hand, the use of proven components is advantageous. During transport, for example when driving through tight curves, the telescope carrier can be retracted to improve maneuverability by shortening the distance between tractor and trailer and therefore shortening the turning radius of the transport vehicle. However, this design requires many special components and is therefore complex. Moreover, the rotor blade could be damaged because during the retracting and extending of the telescope carrier the support of the rotor blade is displaced along the rotor blade as well.

DE 100 31 024 B4 describes a combined transporting train for transportation of long and short material, comprising a tractor and a trailer, wherein an electrical steering device is provided which is steering the trailer as a function of the steering angle of the tractor and which provides an additional function allowing the trailer to be steered independently of the steering angle. A bolster is provided in the rear part of the tractor, the bolster being rotatably mounted on the tractor by the aid of a hinge device in form of a fifth wheel coupling. The trailer has two rigid axles and is provided with two bolsters. The pick-up of the steering angle of the tractor occurs between the bolster and the frame of the tractor and an electronic signal representing the steering angle is transmitted to the trailer via a connection line and is delivered to a computing unit arranged on the trailer. The computing unit is programmed such that a nominal angle of the trailer can be calculated as a function of the specific configuration and/or driving parameters of the combined transporting train. Two hydraulic steering cylinders provided at the trailer are controlled by the computing unit in such a way that the nominal angle is set. Here, the steering cylinders engage a steering arm unit, which is arranged rotatably fixed below a rotating assembly, wherein the rotating assembly connects an undercarriage carrying the two axles of the trailer and an upper carriage rotatably hinged on the undercarriage.

Starting from this, it is an object of the present invention to improve a transport vehicle of the afore-mentioned kind in such a way that the maneuverability and agility of the transport vehicle is improved.

To achieve this and other objects, according to the invention a heavy load vehicle having the features of claim 1 is provided.

Because it is provided that the trailer and the carrier are rotatable in relation to each other about a vertical axis of the transport vehicle, a rotatable bolster steering is formed. In an advantageous embodiment of the invention the rotatable bolster steering advantageously comprises a rotating assembly or bolster, which is arranged in an appropriate manner approximately in the center of the trailer, wherein it is connected torque proofed with the carrier and can rotate about the vertical axis in relation to the trailer serving as a turntable, said vertical axis extending through the center of the rotating assembly or bolster.

The trailer provides one or more rigid axles and at least one steering axle, so that the maneuverability and agility of the trailer can be further improved in combination with the rotatable bolster steering. Advantageously, the steering axle is the foremost axle or are the front axles of the trailer, which can be steered in an appropriate manner actively, either as a function of the orientation of the tractor and the carrier in relation to the trailer, or as a function of the rotational movements of the carrier in relation to the trailer about the vertical axis, or independently thereof.

For steering the transport vehicle it has advantageously a first steering mode for road or highway transport, according to which the carrier rotates freely in relation to the trailer about a vertical axis extending through the center of the rotating assembly. Such rotational movements are detected or gathered by means of a steering pick-up device, in order to steer the steering axle of the trailer in dependence of these rotational movements. For that, the transport vehicle or the trailer respectively comprises a hydraulic circuit with a plurality of hydraulic cylinders, from which at least one directly or indirectly acts on the at least one steering axle of the trailer and at least one another hydraulic cylinder is part of a steering pick-up device, which senses the rotational movements of the carrier in relation to the trailer, wherein hydraulic fluid is exchanged between the hydraulic cylinders via the hydraulic circuit to retract or extend the hydraulic cylinder acting on the steering axle according to the respective rotational movement of the carrier and thus tracking the wheels of the steering axle according to the rotational movements of the carrier. Together with the rigid axles of the trailer said first steering mode ensures a good direction stability.

When driving through tight curves the transport vehicle provides preferably a second steering mode, according to which during the transport the steering axle of the trailer and eventually the rotation of the rotating assembly can be changed actively and in a controlled manner in relation to the trailer by feeding additional hydraulic fluid in the hydraulic circuit. This allows to turn the wheels of the at least one steering axle of the trailer in a desired amount or to rotate the trailer in relation to the carrier about the vertical axis of the vehicle, which runs through the center of the rotating assembly, without changing the orientation of the trailer.

By these means the longitudinal center axis of the trailer can be pivoted, when necessary, in relation to the longitudinal center axis of the carrier in a desired amount and in this manner the trailer can be steered through curves having almost any curve radii. At the same time the rotor blade can be fixed on the carrier, so that it is not subject to any forces resulting from the driving dynamics during the transport.

A further preferred embodiment of the invention provides that the trailer is displaceable in direction of its longitudinal axis in relation to the carrier, thus the whole length of the transport vehicle during unladen transport can be shortened significantly and thus the maneuvreability can be further improved.

According to a further preferred embodiment of the invention the carrier is formed furthermore as a telescope carrier, which is telescoping in the direction of its longitudinal axis, thus its length can be considerably shortened, for example for an unladen transport.

In order to enable to displace such a trailer in direction of its longitudinal axis in relation to the carrier, the carrier comprises at least two and advantageously at least three adjacent telescoping elements, wherein the respective front element can be inserted at least partially in the hollow inside of the adjacent rear element, and wherein the outside of the rearmost element is provided with a linear guidance for the trailer, so that the trailer can also be moved along the carrier or along the rearmost element of the carrier when all or a part of the telescoping elements of the carrier are slid into one another.

In order to fix the trailer at a desired position along the carrier or along the rearmost element of the carrier, advantageously braking or locking devices are provided between the carrier and the trailer, which are arranged in an appropriate manner in the region of said linear guidance. The displacement of the trailer in relation to the carrier is carried out preferably with the help of the tractor, by releasing the braking or locking devices, blocking the wheels of the trailer and moving the tractor forward or backward together with the carrier to displace the carrier forward or backward in relation to the standing trailer. In an according manner also the elements of the telescoping carrier can be slid into one another or pulled apart with help of the tractor by moving the tractor forward or backward after a locking mechanism between adjacent elements is released and the brake or locking device between the carrier and the trailer as well as the wheels of the trailer are blocked, so that the trailer forms an immobile abutment.

A further advantageous embodiment of the invention provides that the goose-neck comprises a device for lifting or lowering of the carrier, so that, when required, the front end of the carrier adjacent to the goose-neck can be lifted or lowered. By this lifting the ground clearance of the carrier behind the tractor is increased, thus the carrier can be moved easier above obstacles, for example a guard railing, marking post or barriers, especially when driving through curves. Thus, the maneuverability and agility can be significantly improved when driving through tight curves, because the carrier can extend along a chord of the curve.

The device for lifting or lowering of the carrier is preferably formed in such a way that by lifting the carrier or the front end of the carrier the distance between the tractor and the trailer is shortened. Thereby a further improvement of the maneuverability is achieved, because in this manner the turning radius of the transport vehicle according to a first alternative of the invention can be shortened even when a telescoping carrier is completely retracted and/or a trailer, which is displaceable in relation to the carrier, has already been moved along the carrier in its foremost end position.

The device for lifting and lowering of the carrier or the front end of the carrier comprises advantageously a parallel steering, integrated in the goose-neck, with two parallel steering rods, which by operation of a hydraulic cylinder can be pivoted between a generally horizontal position or a position being slightly downwards and rearwards inclined relative to the tractor into a generally vertical position or a position being steeply upwards and rearwards inclined relative to the tractor by lifting the front end of the carrier.

The one or more parallel steering devices and the one or more hydraulic cylinders of the device for lifting and lowering of the front end of the carrier are arranged in an appropriate manner between a support part of the goose-neck, the support part resting on the rear part of the tractor and being, in relation to the tractor, rotatable about a vertical axis of the transport vehicle, and a generally horizontally aligned neck part of the goose-neck, which protrudes the rear part of the tractor.

Because the inclination of the carrier changes along its entire length during the lifting and lowering of the front end of the carrier, the carrier is advantageously pivotable in relation to the trailer about an axis vertically aligned to the longitudinal axis of the carrier, the axis being parallel to the ground, so that a change of the inclination of the carrier does not lead to an introduction of forces into the trailer or a change of the loads applied onto the axles of the trailer. The pivoting axis of the carrier is advantageously arranged between the rotating assembly and a supporting plate, which is supported on the rotating assembly, serving as support for the carrier and is which can be preferably displaced along the carrier.

In the following the invention is described in more detail with reference to the embodiment shown in the accompanying figures.

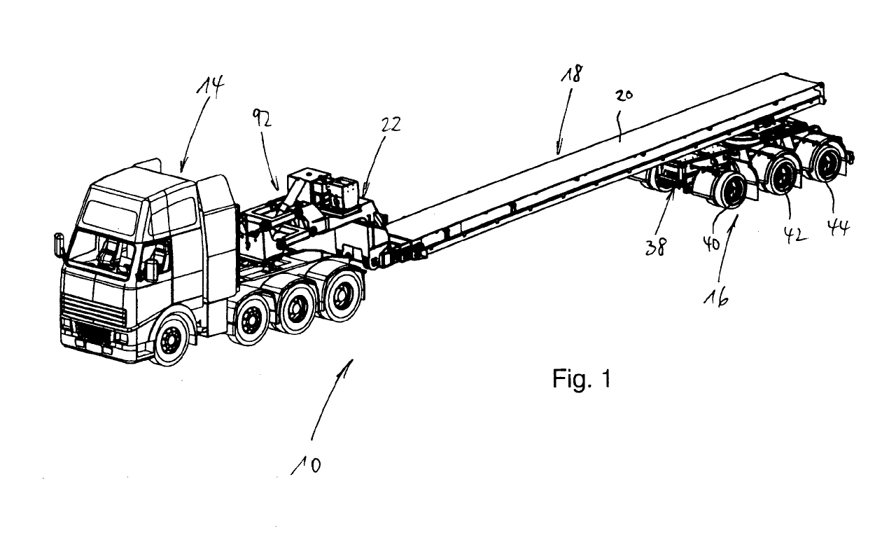

FIG. 1 shows a perspective view of an unloaded heavy-load transport vehicle according to the invention with a tractor and a trailer connected to the tractor via a telescope carrier having a goose-neck;

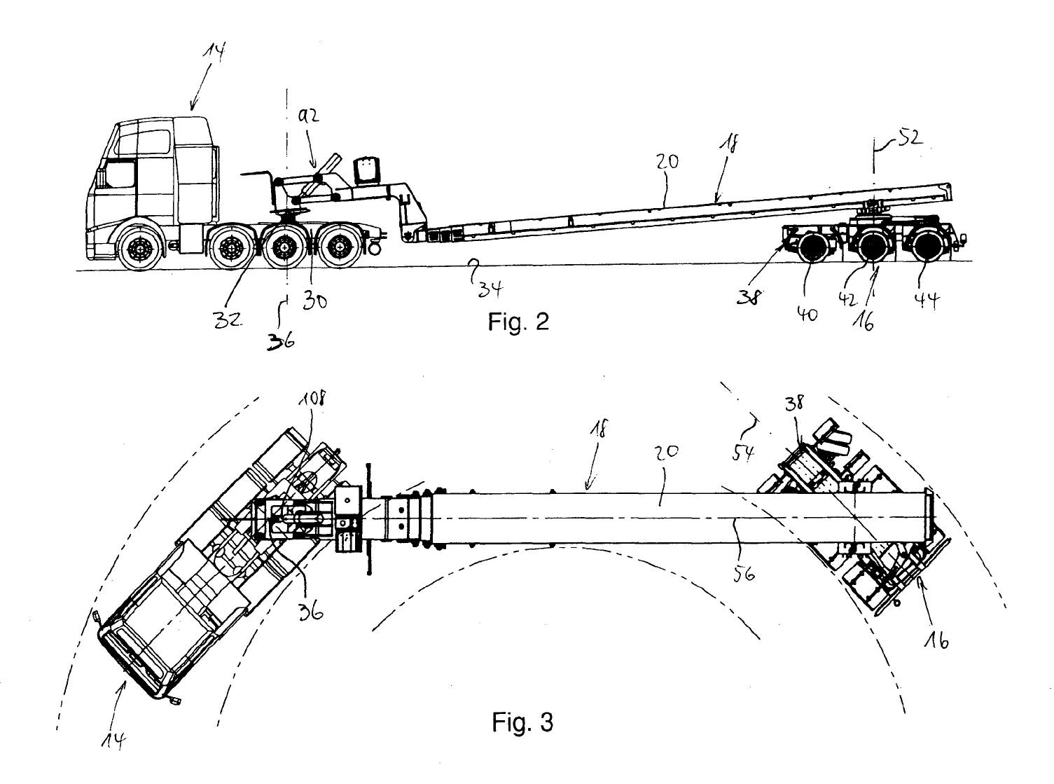

FIG. 2 shows a side view of the unloaded transport vehicle;

FIG. 3 shows a top view of the unloaded transport vehicle when driving through a curve;

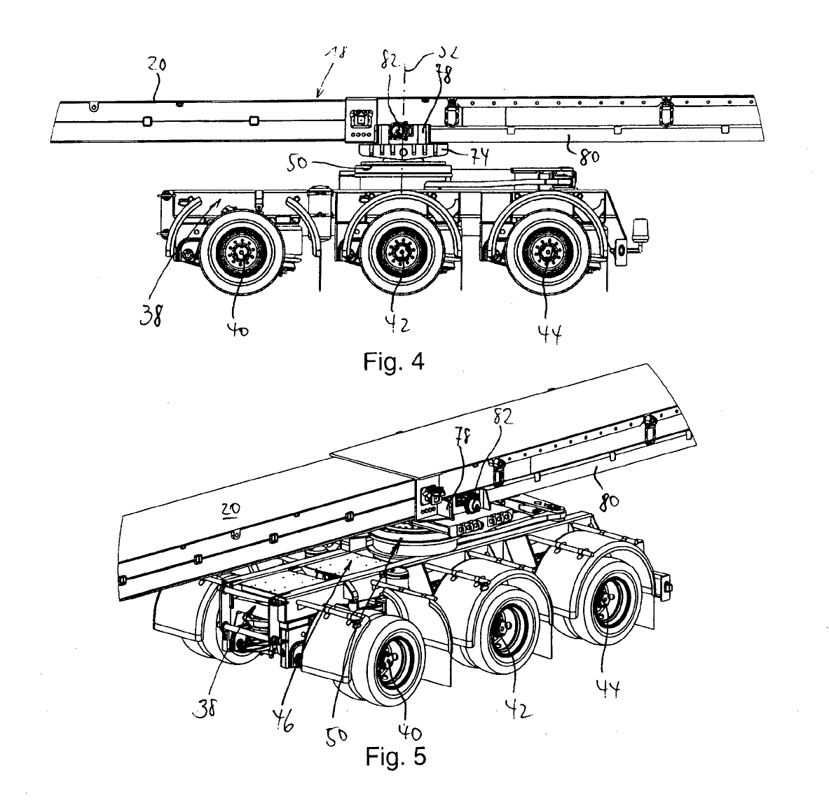

FIG. 4 shows an enlarged side view of the trailer and a part of the telescope carrier;

FIG. 5 shows an enlarged perspective view of the trailer and a part of the telescope carrier when driving straight ahead;

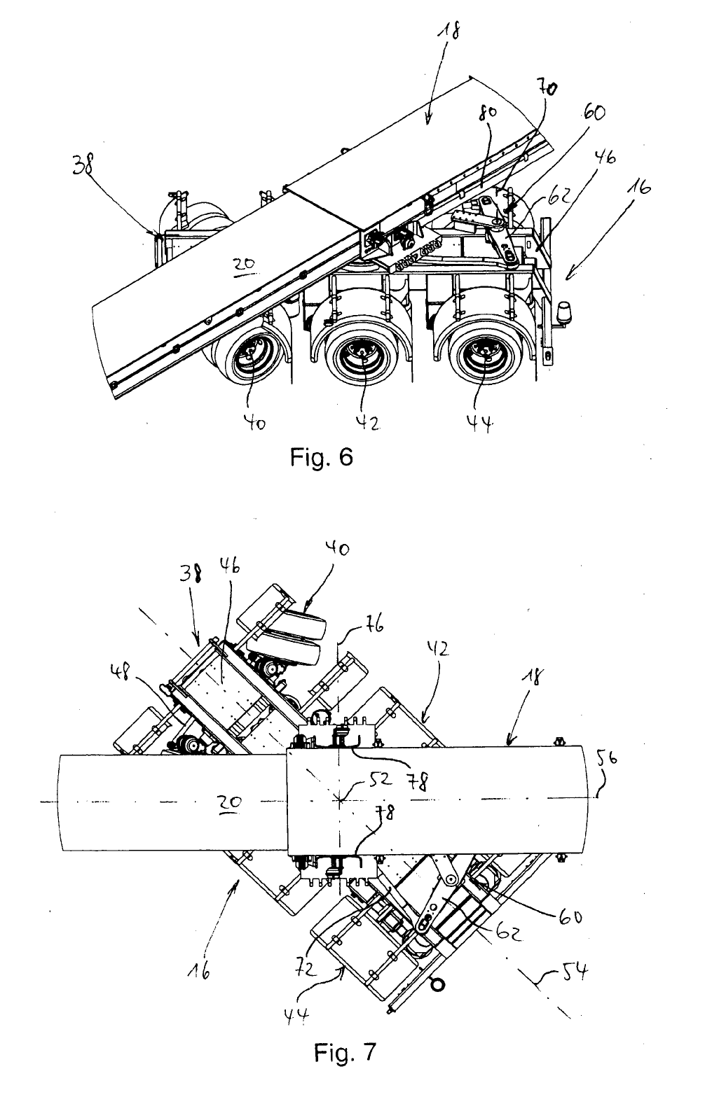

FIG. 6 shows another perspective view of the trailer and a part of the telescope carrier when driving through a curve;

FIG. 7 shows a top view of the trailer and a part of the telescope carrier when driving through a curve;

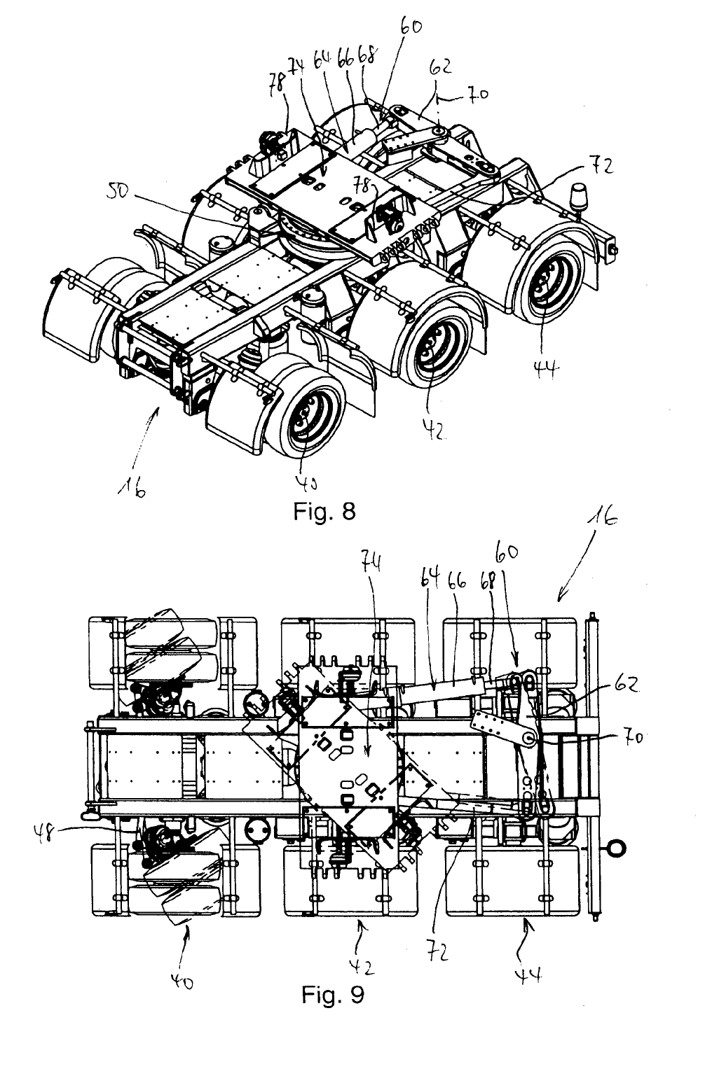

FIG. 8 shows a perspective view of the trailer;

FIG. 9 shows a top view of the trailer;

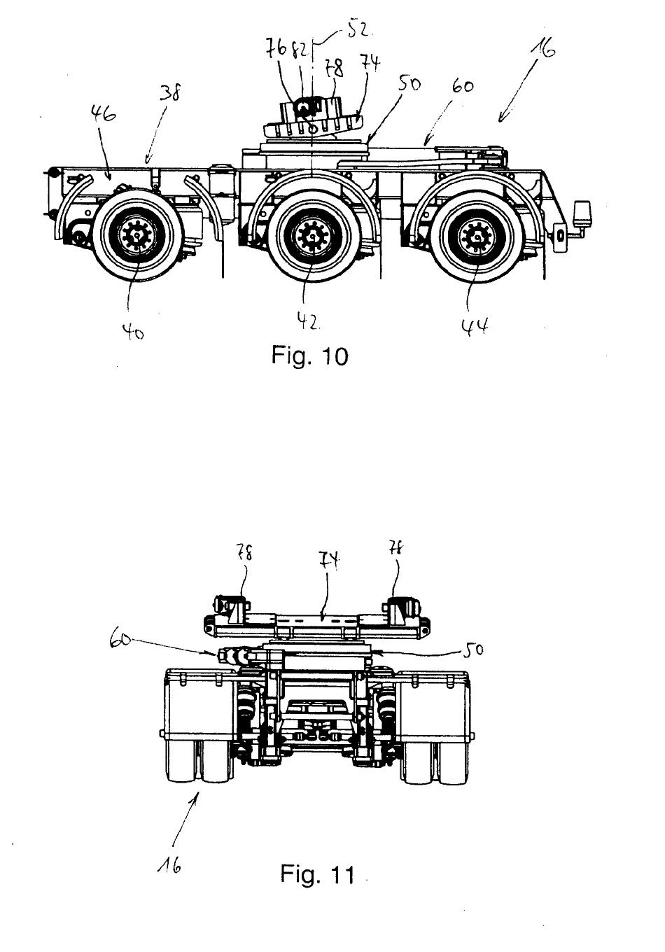

FIG. 10 shows a side view of the trailer;

FIG. 11 shows a back view of the trailer;

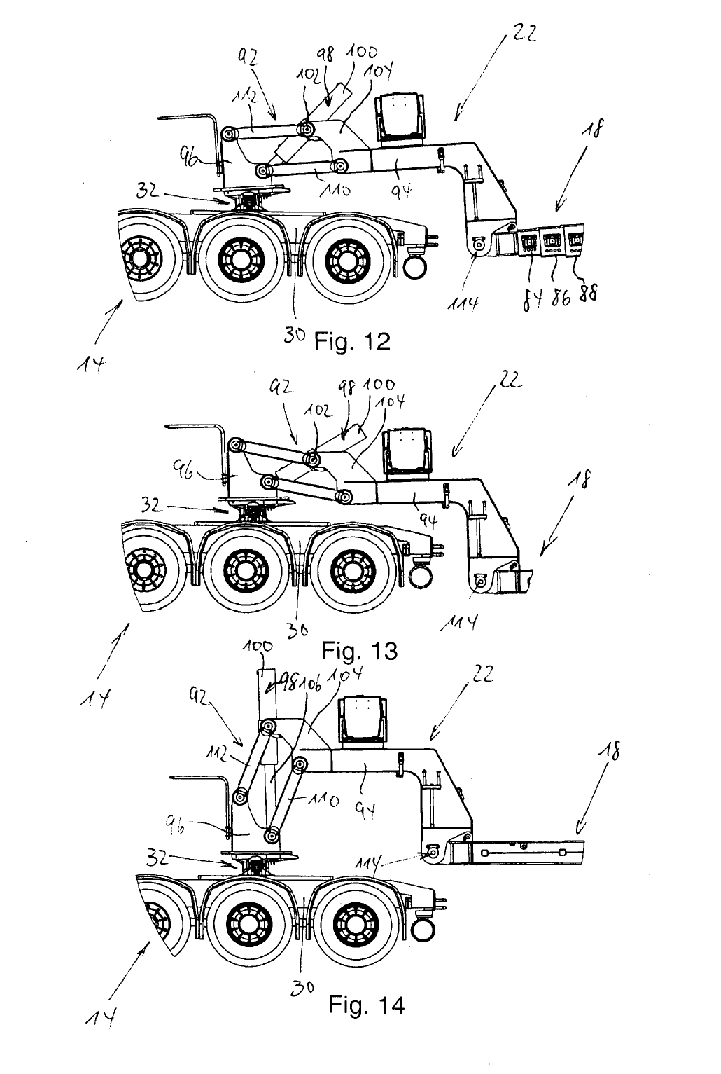

FIG. 12 shows a side view of the goose-neck in a position where the front end of the carrier substantially has the same ground clearance as the tractor;

FIG. 13 shows a side view of the goose-neck in a position where the front end of the carrier is slightly lowered;

FIG. 14 shows a side view of the goose-neck in a position where the front end of the carrier is lifted;

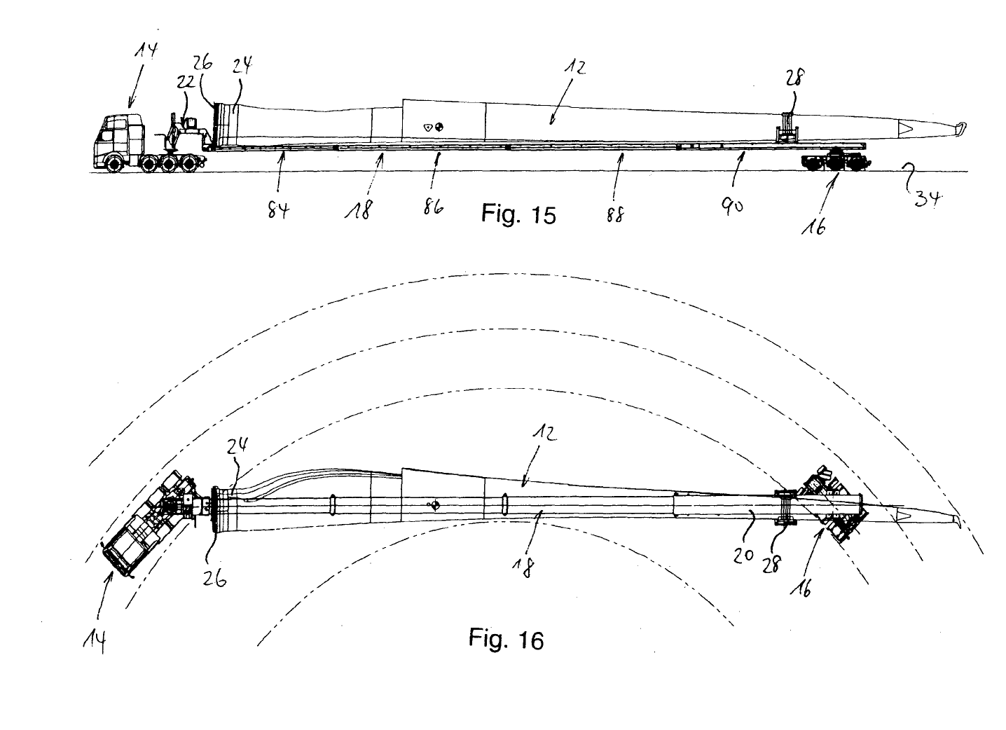

FIG. 15 shows a side view of the transport vehicle loaded with a rotor blade;

FIG. 16 shows a top view of the loaded transport vehicle when driving through a curve with a larger radius;

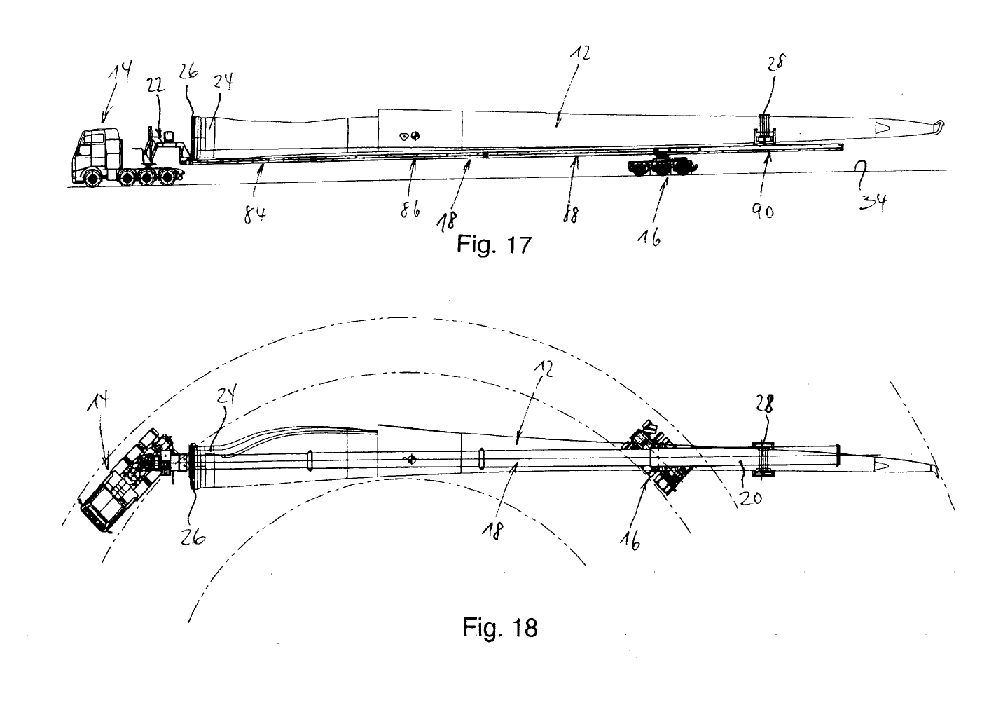

FIG. 17 shows a side view of the transport vehicle loaded with the rotor blade, wherein the distance between tractor and trailer is shortened;

FIG. 18 shows a top view of the loaded transport vehicle when driving through a curve with a smaller radius.

The heavy-load transport vehicle 10 shown in the drawing serves for transporting a rotor blade 12 of a wind turbine, as shown in FIGS. 15 to 18.

The transport vehicle 10 consists essentially of a tractor 14, a three-axles trailer 16 arranged at a distance behind the tractor 14, and a telescope carrier 18 providing a load supporting surface 20 for the rotor blade 12 and which is connected to the tractor 14 at its front end by a goose-neck 22. As shown in FIGS. 15 to 18, during the transporting of a rotor blade 12 its root part 24 is arranged on the front end of the pulled apart telescope carrier 18, so that an essential part of the load of the rotor blade 12 is supported on the tractor 14 via the goose-neck 22. The root part 24 is tightly screwed at a holder 26 fixed at the foremost end of the carrier 18 and protrudes the load supporting surface 20. For safety reasons, the rear part of the rotor blade 12 is connected to the carrier 18 via a further holder 28. The rotor blade 12 is immovably fixed in relation to the carrier 18 by the holders 26, 28.

A common tractor suitable for a heavy-load transport vehicle 10 is used as tractor 14 providing on its flat rear part 30 a coupling device 32 for coupling the goose-neck 22, so that the latter is rotatable in relation to the tractor 14 about a first vertical axis 26 of the transport vehicle 10 being vertical to the ground.

As best shown in FIGS. 4 to 10, the trailer 16 provides a chassis 38, at which the wheels of three axles 40, 42, 44 are fixed on both sides of a longitudinal carrier 46. The two rear axles 42, 44 are rigid axles with non-steerable wheels. The front axle 40 is a steering axle with wheels which are steerable by a hydraulic axle steering device with two hydraulic cylinders (not shown) arranged in the chassis 38 of the trailer 16, which are controlling the wheel pairs of the steering axle via track rods 48 (FIG. 7 and 9).

Above the center axle 42 the trailer 16 has a rotating assembly/slewing ring 50 positioned on the longitudinal carrier 46, where a rear end part of the telescope carrier 18 rests with a part of the load on the trailer 16 via the rotating assembly 50. The rotating assembly 50 is part of a rotating bolster steering of the trailer 16 and is therefore also called bolster table within the scope of this patent application. The rotating assembly 50 is rotatable in relation to the trailer 16 about a second vertical axis 52 of the vehicle 10 which is vertical to the ground 34 and is connected torque proof with the rear part of the telescope carrier 18, so that, when steering the trailer 16, the orientation or angular position of its longitudinal axis 54 can be varied in relation to the longitudinal axis 56 of the telescope carrier 18. While the longitudinal axes 54, 56 align when driving straight ahead, as shown in FIG. 1, 4 and 5, the longitudinal axes 54, 56 in a top view include an angle between them when driving through curves, as shown in FIG. 3, 6 and 7.

As best shown in FIGS. 6 to 8, the rotating bolster steering of the trailer 16 comprises a steering pick-up 60 with a two-arm steering lever 62 and a hydraulic cylinder 64, whose cylinder tube 66 is hinged on the rotating assembly 50 and its piston rod 68 is hinged at the end of the lever arm of the two-arm steering lever 62, which is pivotable in relation to the trailer 16 about a third vertical axis 70 of vehicle 10. The end of the other longer lever arm of the steering lever 62 is connected to the rotating assembly 50 via a coupling rod 72.

The hydraulic cylinder 64 of the steering pick-up 60 and the two hydraulic cylinders of the axle steering device of the steering axle 40 are part of a hydraulic circuit (not shown) of vehicle 10, which allows to steer the trailer 16 in two different steering modes.

In a first standard steering mode which is designed for road and highway transports, the steering pick-up 60 picks up the rotation of the rotating assembly 50 in relation to the trailer 16 during the transport, which is caused by the tractor 14 and the telescope carrier 18 during driving through curves, in order to control the steering axle 40 as a function of this rotation. In this steering mode hydraulic fluid is exchanged between the hydraulic cylinder 64 of the steering pick-up 60 and the hydraulic cylinders of the steering axle 40 communicating with said hydraulic cylinder 64 by pushing hydraulic fluid from the hydraulic cylinder 64 in the hydraulic cylinders of the steering axle 40 or by forwarding hydraulic fluid from the hydraulic cylinders of the steering axle 40 into the hydraulic cylinder 64, so that the wheels of the steering axle 40 are turned according to the rotation of the telescope carrier 18 in relation to the trailer 16. In this steering mode the trailer 16 follows the way which is given by the tractor 14, while the two rigid axles 42, 44 of the trailer 16 ensure a good directional stability.

In a second steering mode, which is especially designed for driving through tight curves, the trailer 16 is steered by an operator via a remote control. In this steering mode hydraulic fluid is specifically fed in the hydraulic circuit, to retract or extend the hydraulic cylinders of the steering axle 40 and therefore to turn the wheels of the steering axle in a desired direction.

If required, the active axle steering device of the steering axle 40, which is manually steered by the operator, can be supported by an active rotating bolster steering, by leading the hydraulic fluid, which is fed into the hydraulic circuit, also to the hydraulic cylinder 62 of the steering pick-up 60 which engages the rotating assembly 50, to retract or extend the hydraulic cylinder and therefore to support the turning of the wheels of the steering axle 40 in the desired direction.

Arranged above the rotating assembly 50 there is a rectangular bearing plate 74, which rests on the rotating assembly 50. The bearing plate 74 is connected torque proofed via a second vertical axis 52 with the rotating assembly 50, the bearing plate 74 is however pivotable in relation to the rotating assembly 50 about an axis 76 which runs transverse to the longitudinal axis 54 of the carrier 18, as best shown in FIG. 10, so that the front end of the carrier 18 can be lowered or lifted, without changing the load acting on the trailer 16 or on the rotating assembly 50. As shown in FIG. 7 and 10, the axes 54, 56 and 76 run, in a top view, through axis 52.

The bearing plate 74 provides two upwardly protruding leading elements 78, arranged at a distance from one another on both sides of the second vertical axis 52, which, in cooperation with two lateral linear guidances 80 of the telescope carrier 18, allow to displace the telescope carrier 18 in direction of its longitudinal axis 56 in relation to the trailer 16. Both leading elements 78 are provided with a braking or locking device 82, so that the telescope carrier 18 can be releasably locked in any displacement position in relation to the trailer.

As can be seen best from FIG. 15 and 17, the telescope carrier 18 comprises four hollow telescoping elements 84, 86, 88, 90, which cross-sectional dimensions decrease in direction to the tractor 14. Thus, the elements 84, 86, 88, 90 can be slid into each other in direction of the longitudinal axis 56 during unloaded transport operations of the transport vehicle 10, as shown in FIG. 1, or can be pulled apart in direction of the longitudinal axis 56 for the transport of a rotor blade 12, as shown in FIG. 15 and 17. The single elements 84, 86, 88, 90 can be locked in different telescoping positions in relation to the respective adjacent element, in order to avoid an undesired displacement of the elements 84, 86, 88, 90 in relation to each other.

For lengthening or shortening of the telescope carrier 18, firstly the locking between the adjacent elements 84, 86; 86, 88; 88, 90, which are to be slid into each other or pulled apart, is released. Afterwards the wheels of the trailer 16 are blocked and the tractor 14 is moved forward for lengthening the telescope carrier 18 or the tractor 14 is moved backwards for shortening the telescope carrier 18, before the elements 84, 86, 88, 90 are locked again in the desired telescope position.

The rearmost element 90 having the largest cross section rests via the bearing plate 74 onto the trailer 16 and is provided with the linear guidances 80 at its longitudinal sides, on which the guiding elements 78 projecting above the bearing plate 74 engage.

As shown in FIG. 15 and 17, the telescope carrier 18 and the trailer 16 are movable in relation to each other, wherein the trailer 16 with the guiding elements 78, which is displaceable between a rear end position, shown in FIG. 15, and a forward end position, shown in FIG. 17, moves along the rearmost element 90 of the telescope carrier 18 (FIG. 17). Therefore, it is possible to significantly shorten or lengthen the radius of a curve driven through by the transport vehicle 10, without any changes of the orientation or angular position of the longitudinal axis 54 of the trailer 16 in relation to the longitudinal axis 56 of the carrier 18 and the tractor 14, as it can be seen by comparing the FIGS. 18 and 16.

By means of the braking or locking device 82, the two guiding elements 78 can be pressed in any desired displacing position from opposite sides against the linear guidance 80, to lock the trailer 16 and the carrier 18 in relation to each other. Accordingly, the guiding elements 78 can be moved transverse to the longitudinal axis 56 slightly away from the linear guiding 80, to enable displacement of the trailer 16 and the carrier 18 in relation to each other.

The displacement of the telescope carrier 18 in relation to the trailer 16 takes place with the aid of the tractor 14, by unlocking the braking or locking devices 82 and locking the wheels of the trailer 16, before then the tractor 14 together with the carrier 18 is moved forward or backward, to displace the carrier 18 in relation to the stationary trailer 16 into the desired direction.

As best shown in FIGS. 12 to 14, the ground clearance of the front end of the telescope carrier 18 can be changed with aid of a lifting and lowering device 92 integrated in the goose-neck 22. Therefore, the front end of the telescope carrier 18 can be lifted or lowered starting from a normal position during a unloaded drive, shown in FIG. 1 and 12, for example to raise the telescope carrier 18 during transport of a rotor blade 12 while driving through a curve above a guard railing which borders the curve on the inner side, or another barrier, or to position the front end of the telescope carrier 18 onto a wooden base (not shown) lying on the ground 34 when decoupling from the tractor 14.

As also best shown in FIGS. 12 to 14, the lowering device 92 is arranged between a neck part 94 of the goose-neck 22, the neck part 94 projecting above the rear part 30 of the tractor 14 and is generally horizontally oriented, and a support part 96 of the goose-neck 22, the support part 96 being supported on the coupling device 32, which is rotatable in relation to the tractor 14 about the vertical axis 36.

The locking device 92 comprises a hydraulic cylinder 98 having a cylinder tube 100, which is hinged approximately at its center at a free end of a thrust bearing projection 104 projecting upward diagonally above the neck part 94, and is pivotable about a pivot axis 102, which is vertical to the longitudinal axis 56 of the carrier 18 and is parallel in relation to the ground 34, while its piston rod 106 is hinged in a pilot joint 108 on the support part 96.

The locking device 92 further comprises a parallel steering with two parallel steering rods 110 and 112 of the same length. The front ends of the two steering rods 110, 112 are hinged on the support part 96 with a height offset and a length offset in direction of the longitudinal axis 56 of the carrier 18, while their rear ends are hinged on the free end of the neck part 94 or on the free part of the thrust bearing projection 104 with an appropriate height offset and length offset, wherein the pivot axis of the rear end of the upper steering rod 112 aligns with the pivot axis 102 of the cylinder tube 100 of the hydraulic cylinder 98 and the pivot axis of the front end of the lower steering rod 110 aligns with the pivot axis of the pilot joint 108 of the piston rod 106 of the hydraulic cylinder 98. By this arrangement the longitudinal center axis of the hydraulic cylinder 98 extends diagonally through a parallelogram limited by the steering rods 110, 112. It is also possible to provide, instead of said parallelogram kinematics with the same or nearly the same steering rods 110, 112, that one of the two steering rods 110 or 112 is slightly shortened. Thus it is achieved, that when lifting the parallelogram defined by the steering rods 110, 112 the kinematic of the coupling device 32 can be better exploited.

When the hydraulic cylinder 98 is wholly retracted, as shown in FIG. 13, both steering rods 110, 112 are tilted backward diagonal and downward with a flat inclination angle seen from the support part 96. In this case the front end of the telescope carrier 18 is in a lowered end position, having its smallest ground clearance.

When the hydraulic cylinder 98 is wholly extended, as in shown in FIG. 14, both steering rods 110, 112 are tilted backward diagonal and downward with a steep inclination angle seen from the support part. In this case the front end of the telescope carrier 18 is in a lifted end position, having its largest ground clearance.

If the hydraulic cylinder 98 is retracted so far, that the two steering rods 110, 112 are oriented approximately parallel to the neck part 94, as shown in FIG. 12, the goose-neck 22 is in a normal position, which it preferably has during an unloaded drive.

As can be seen when comparing the FIGS. 12 to 14, not only the ground clearance is enlarged due to the lifting of the front end of the carrier 18, but also the distance between tractor 14 and trailer 16 is slightly shortened. In this manner the smallest turning radius of the transport vehicle 10 can be made even smaller, even if the trailer 16 in relation to the telescope carrier 18 is already moved in its foremost end position, shown in FIGS. 17 and 18.

Although during the lifting and lowering of the front end of the telescope carrier 18 also the inclination angle of its longitudinal axis 56 is changed, this has no effect on the trailer 16 in none of its orientations, because the rearmost element 90 of the telescope carrier 18 is supported on the bearing plate 74 and the latter is pivotable in relation to the rotating assembly 50 about axis 76.

In case the tractor 14 is needed otherwise, the front end of the telescope carrier 18 can be lowered by the device 92 onto a pad lying on the floor 34, and then the goose-neck 22 can be decoupled from the tractor 14 together with the telescope carrier 18 in the region of the coupling device 32.

Furthermore, the goose-neck 22 is also connected to the rest of the telescope carrier 18 via a releasable coupling 114, so that the telescope carrier 18 can be replaced, if necessary, with a shorter or longer telescope carrier 18.

1. A heavy-load transport vehicle (10) for transporting an elongated object, having a tractor (14), a multi-axle trailer (18) and a carrier (18) for the elongated object supported on the trailer and on the tractor (14), wherein the trailer (16) and the carrier (18) are rotatable in relation to each other about a vertical axis (52) of the transport vehicle (10), the trailer (16) having at least one rigid axle (42, 44) and at least one steering axle (40), and in a first steering operation mode during transport the steering axle (40) of the trailer (16) is steerable in relation to the trailer (18) about the vertical axis (52) as a function of the rotational movements of the carrier (18) by means of a hydraulic circuit comprising at least two acts off the steering axle (40) and at least one other hydraulic cylinder (64) picks up rotational movements of the carrier (18) in relation to the trailer (16), and wherein hydraulic fluid is exchanged between the hydraulic cylinders by the hydraulic circuit, characterized by a second steering operation mode, according to which, during the transport, the steering axle (40) of the trailer (16) is steerable actively and Independently from the movements of the tractor (14) and the trailer (18), and characterized by a device amount of hydraulic fluid in a hydraulic circuit.

2. The heavy-load transport vehicle according to claim 1, characterized by a rotating assembly connected torque proofed with the carrier (18) and being rotatable in relation to the trailer (16) about the vertical axis (52).

3-5. (canceled)

6. The heavy-load transport vehicle according to claim 1, characterized in that the carrier (18) is displaceable in direction of its longitudinal axis (56) in relation to the trailer (16).

7. The heavy-load transport vehicle according to claim 8, characterized by braking or locking devices (82) arranged between the carrier (18) and the trailer (16), and that, after release of the braking or locking devices (82), the carrier (18) is displaceable in direction of its longitudinal axis (56) in relation to the trailer (16) by means of the tractor (14).

8. The heavy-load transport vehicle according to claim 6, characterized in that the carrier (18) comprises at least two adjacent telescopic elements (84, 86, 88, 90), that each respective front element is at least partially insertable into the hollow inside of the respective rear element, and that the outside of the rearmost element (90) is provided with a linear guidance (80) for the trailer (16).

9. The heavy-load transport vehicle according to one of the previous claims claim 1, characterized in that the goose-neck (22) comprises a device (92) for lifting and lowering the front end of the carrier (18).

10. The heavy-load transport vehicle according to claim 9, characterized in that the distance between the tractor (14) and the trailer (16) is shortened by the lifting of the carrier (18).

11. The heavy-load transport vehicle according to claim 9, characterized in that the device for lifting and lowering of the front end of the carrier (18) comprises at least one parallelogram kinematics (98) and a parallel steering (110, 112).

12. The heavy-load transport vehicle according to claim 9 characterized in that the device for lifting and lowering of the front end of the carrier (18) is arranged between a generally horizontally oriented neck part (94) of the goose-neck (22) and a support part (96) of the goose-neck (22) which is borne on the tractor (14) and is rotatable in relation to the tractor (14).

13. The heavy-load transport vehicle according to claim 1, characterized in that the carrier (18) is pivotable in relation to the trailer (16) about a pivot axis (76) which is vertical to a longitudinal axis (56) of the carrier (18) and parallel to the ground.
